(19) United States
(12) Patent Application Publication
(10) Pub. No.: US 2023/0297958 A1
(43) Pub. Date: Sep. 21, 2023

(54) POLICY CREATION APPARATUS, CONTROL APPARATUS, POLICY CREATION METHOD, AND NON-TRANSITORY COMPUTER READABLE MEDIUM STORING PROGRAM

(71) Applicant: NEC Corporation, Minato-ku, Tokyo (JP)

(72) Inventors: Yukiko TAKAHASHI, Tokyo (JP); Yuzuru Okajima, Tokyo (JP)

(73) Assignee: NEC Corporation, Minato-ku, Tokyo (JP)

(21) Appl. No.: 18/018,830

(22) PCT Filed: Aug. 3, 2020
(86) PCT No.: PCT/JP2020/029605

§ 371 Date: Jan. 30, 2023

(51) Int. Cl. G06Q 10/10

(52) U.S. Cl. CPC G06Q 10/10

(57) ABSTRACT

A policy creation apparatus capable of creating policies with high quality and high visibility is provided. A rule creation unit (302) creates a plurality of rule sets including a plurality of rules that are a combination of a condition for determining a necessity of an action to be taken regarding an object and the action to be performed when the condition holds. An order determination unit (304) determines an order of the rules in each of the plurality of rule sets. An action determination unit (306) determines whether or not the condition holds in accordance with the determined order, and determines the action when the condition holds.

### TECHNICAL FIELD

The present disclosure relates to a policy creation apparatus configured to create policies, a control apparatus, a policy creation method, and a non-transitory computer readable medium storing a program.

### BACKGROUND ART

Workers in processing plants, etc. are able to manufacture high-quality products by familiarizing themselves with work procedures for creating products from materials. In the work procedures, for example, the workers process the materials using processing machines. Work procedures for manufacturing good products are accumulated as know-how for each worker. In order to transfer the know-how from workers who are familiar with the work procedures to other workers, however, skilled workers need to teach how to use the processing machines, amounts of materials, timings to put the materials into the processing machines, etc. to other workers. Therefore, the transfer of know-how requires a long period of time and a lot of work.

As illustrated in Non-Patent Literature 1, as a method of learning the above know-how by machine learning, a reinforcement learning method may be used. In the reinforcement learning method, policies indicating the know-how are expressed by a form of models. In Non-Patent Literature 1, these models are expressed by a neural network.

### CITATION LIST

### Non-Patent Literature

[Non-Patent Literature 1] Richard S. Sutton and Andrew G. Barto, Reinforcement Learning: An Introduction. The MIT Press, 2017

### SUMMARY OF INVENTION

### Technical Problem

However, it is difficult for a user to understand how the know-how has been expressed. The reason therefor is that, since the reinforcement learning method illustrated in Non-Patent Literature 1 expresses the policies indicating the know-how by a neural network, it is difficult for the user to understand the models created by the neural network.

The present disclosure has been made in order to solve the aforementioned problem and one of the objects of the present disclosure is to provide a policy creation apparatus, a control apparatus, a policy creation method, and a program capable of creating policies with high quality and high visibility.

### Solution to Problem

A policy creation apparatus according to the present disclosure includes: rule creation means for creating a plurality of rule sets including a plurality of rules, each of the rules being a combination of a condition for determining a necessity of an action to be taken regarding an object and the action to be performed when the condition holds; order determination means for determining an order of the rules in each of the plurality of rule sets; and action determination means for determining whether or not the condition holds in accordance with the determined order, and determining the action when the condition holds.

Further, a policy creation method according to the present disclosure is performed by an information processing apparatus, and includes: creating a plurality of rule sets including a plurality of rules, each of the rules being a combination of a condition for determining a necessity of an action to be taken regarding an object and the action to be performed when the condition holds; determining an order of the rules in each of the plurality of rule sets; and determining whether or not the condition holds in accordance with the determined order, and determining the action when the condition holds.

Further, a program according to the present disclosure causes a computer to achieve: a function of creating a plurality of rule sets including a plurality of rules, each of the rules being a combination of a condition for determining a necessity of an action to be taken regarding an object and the action to be performed when the condition holds; a function of determining an order of the rules in each of the plurality of rule sets; and a function of determining whether or not the condition holds in accordance with the determined order, and determining the action when the condition holds.

### Advantageous Effects of Invention

According to the present disclosure, it is possible to provide a policy creation apparatus, a control apparatus, a policy creation method, and a program capable of creating policies with high quality and high visibility.

### BRIEF DESCRIPTION OF DRAWINGS

FIG. 1 is a block diagram showing a configuration of a policy creation apparatus according to a first example embodiment;

FIG. 2 is a flowchart showing a policy creation method executed by the policy creation apparatus according to the first example embodiment;

FIG. 3 is a flowchart showing a policy creation method executed by the policy creation apparatus according to the first example embodiment;

FIG. 4 is a flowchart showing a policy creation method executed by the policy creation apparatus according to the first example embodiment;

FIG. 5 is a diagram conceptually showing processing of determining an action in accordance with a policy according to the first example embodiment;

FIG. 6 is a diagram conceptually showing one example of a target according to the first example embodiment;

FIG. 7 is a diagram illustrating the rule set created by the rule creation unit according to the first embodiment;

FIG. 8 is a diagram for describing an example of processing for generating a probabilistic decision list calculated by an order parameter calculation unit according to a second example embodiment;

FIG. 9 is a diagram for describing updating of order parameters, according to the second example embodiment;

FIG. 10 is a diagram for describing processing of generating the decision list by an order determination unit according to the second example embodiment;

FIG. 11 is a diagram showing a configuration of a policy creation apparatus according to a third example embodiment;

FIG. 12 is a flowchart showing a policy creation method executed by the policy creation apparatus according to the third example embodiment; and

FIG. 13 is a block diagram schematically showing a hardware configuration example of a calculation processing device capable of achieving the policy creation apparatus according to each of the example embodiments.

### EXAMPLE EMBODIMENTS

### First Example Embodiment

Hereinafter, with reference to the drawings, example embodiments will be described. For the sake of clarification of the description, the following descriptions and the drawings are omitted and simplified as appropriate. Further, throughout the drawings, the same components are denoted by the same reference symbols and overlapping descriptions are omitted as appropriate.

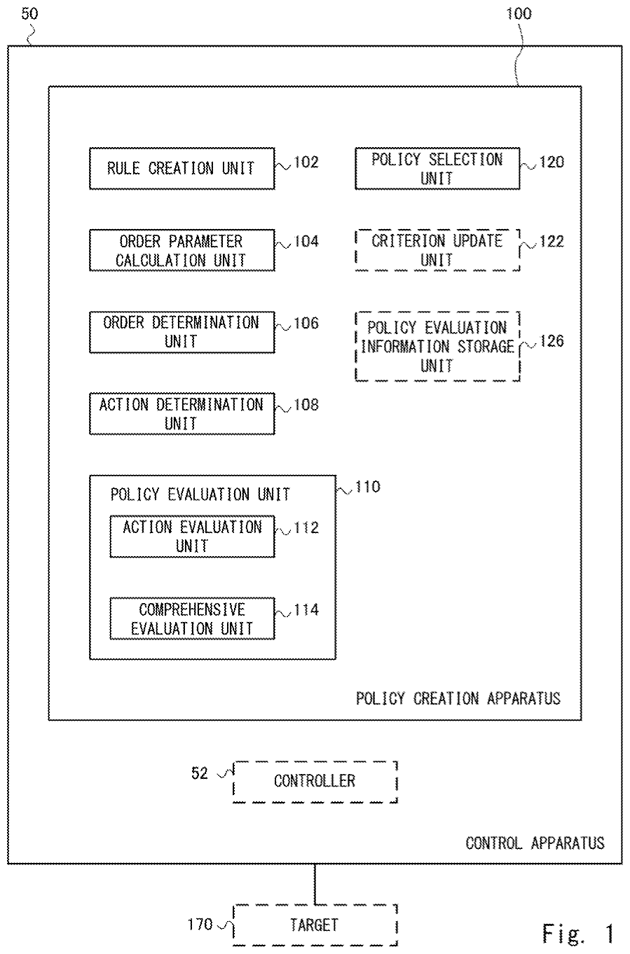

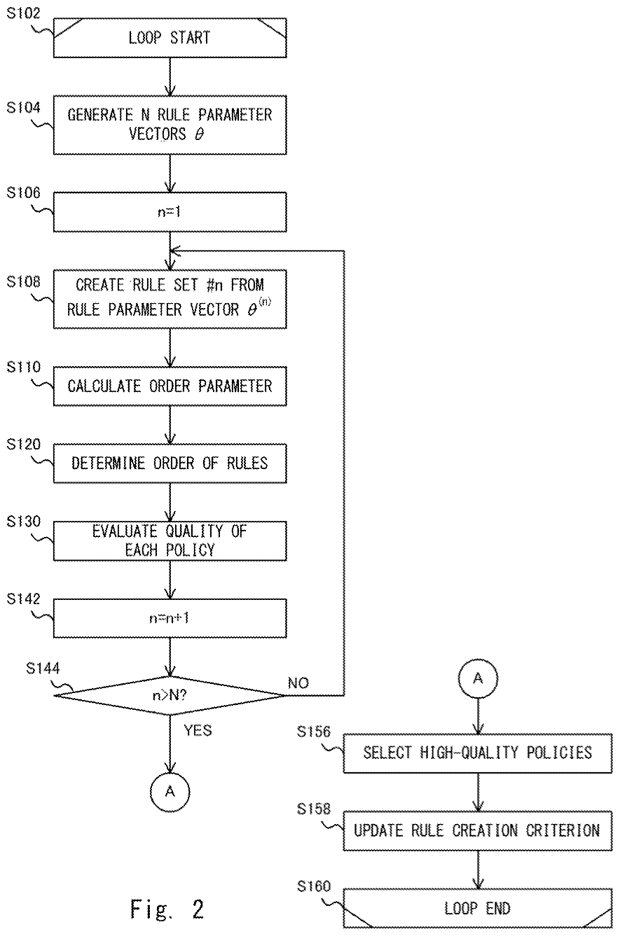

FIG. 1 is a block diagram showing a configuration of a policy creation apparatus 100 according to a first example embodiment. Further, FIGS. 2 to 4 are flowcharts showing a policy creation method executed by the policy creation apparatus 100 according to the first example embodiment. Note that the flowchart shown in FIGS. 2 to 4 will be described later.

With reference to FIG. 1, a configuration of the policy creation apparatus 100 according to the first example embodiment of the present disclosure will be described in detail. The policy creation device 100 is, for example, a computer. The policy creation apparatus 100 according to the first embodiment includes a rule creation unit 102, an order parameter calculation unit 104, an order determination unit 106, an action determination unit 108, a policy evaluation unit 110, and a policy selection unit 120. The policy evaluation unit 110 includes an action evaluation unit 112 and a comprehensive evaluation unit 114. The policy creation apparatus 100 may further include a criterion update unit 122 and a policy evaluation information storage unit 126.

The rule creation unit 102 includes a function as rule creation means. The order parameter calculation unit 104 includes a function as order parameter calculation means. The order determination unit 106 includes a function as order determination means. The action determination unit 108 includes a function as action determination means. The policy evaluation unit 110 includes a function as policy evaluation means. The action evaluation unit 112 includes a function as action evaluation means. The comprehensive evaluation unit 114 includes a function as comprehensive evaluation means. The policy selection unit 120 includes a function as policy selection means. The criterion update unit 122 includes a function as criterion update means. The policy evaluation information storage unit 126 includes a function as policy evaluation information storage means.

The policy creation apparatus 100 executes processing in, for example, a control apparatus 50. The control apparatus 50 includes the policy creation apparatus 100 and a controller 52. The policy creation apparatus 100 creates a policy represented by a decision list by using the rule creation unit 102, the order parameter calculation unit 104 and the order determination unit 106. The controller 52 executes control regarding a target 170 in accordance with an action determined according to a policy created by the policy creation apparatus 100. The policy indicates information that is a basis for determining the action to be taken regarding the target 170 when the target 170 is in one state. The method of creating the policy represented by the decision list will be described later.

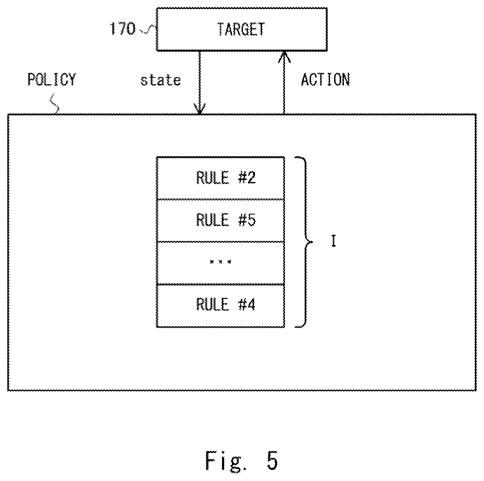

FIG. 5 is a diagram conceptually showing processing of determining an action in accordance with a policy according to the first example embodiment. As illustrated in FIG. 5, in the policy creation apparatus 100, the action determination unit 108 acquires information indicating a state of the target 170. Then the action determination unit 108 determines an action to be taken regarding the target 170 in accordance with the created policy. The state of the target 170 (i.e., object) can be expressed, for example, by observation values output by a sensor that observes the target 170. The sensor is, for example, a temperature sensor, a position sensor, a velocity sensor, an acceleration sensor or the like.

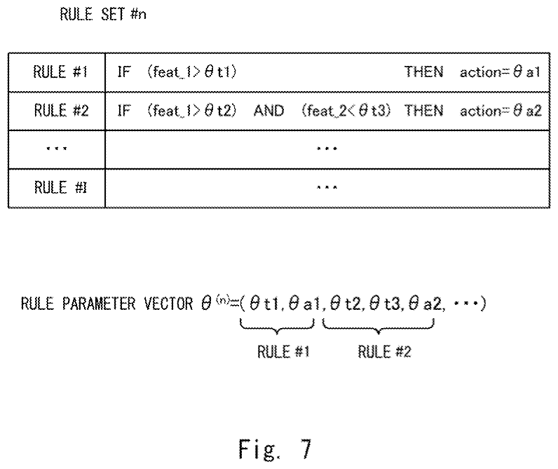

In this example embodiment, the policy is represented by the decision list. The decision list is an ordered list of a plurality of rules in which conditions for determining the state of the target 170 are combined with actions in that state. The conditions are represented, for example, as the state (or observation value) expressed by a certain feature amount (type of observation) is equal to or greater than the criterion (threshold), is less than the criterion, or matches the criterion. When the state is given, the action determination unit 108 follows this decision list in order, adopts the first rule that meets the condition, and determines the action of the rule as an action to be performed on the target 170. Details of the rules will be described later with reference to FIG. 7.

For example, in the example shown in FIG. 5, the decision list (the policy) is composed of I rules #1 to #I (I is an integer greater than or equal to 2). Then, in the decision list, the order of these rules #1 to #I is defined. In the example shown in FIG. 5, the first rule is rule #2, the second rule is rule #5, and the I-th rule is rule #4. When a certain state is given, the action determination unit 108 determines whether the state conforms to the condition of rule #2. If the given state conforms to the conditions of rule #2, the action determination unit 108 determines the action corresponding to rule #2 as the action to be performed on the target 170. On the other hand, if the given state does not conform to the condition of rule #2, the action determination unit 108 determines whether the state conforms to the condition of rule #5 following rule #2. Then, if the given state conforms to the condition of rule #5, the action corresponding to rule #5 is determined as the action to be performed on the target 170. The same is true for the following rules.

When, for example, the target 170 is a vehicle such as a self-driving vehicle, the action determination unit 108 acquires, for example, observation values (values of feature amounts) such as the number of rotations of an engine, the velocity of the vehicle, a surrounding environment and the like. The action determination unit 108 determines an action by executing the above-described processing based on these observation values (values of feature amounts). Specifically, the action determination unit 108 determines an action such as turning the steering wheel to the right, pressing the accelerator, or applying brakes. The controller 52 controls the accelerator, the steering wheel, or the brakes according to the action determined by the action determination unit 108.

Further, when, for example, the target 170 is a power generator, the action determination unit 108 acquires, for example, observation values (values of feature amounts) such as the number of rotations of a turbine, the temperature of an incinerator, or the pressure of the incinerator. The action determination unit 108 determines an action by executing the above-described processing based on these observation values (values of feature amounts). Specifically, the action determination unit 108 determines an action such as increasing or decreasing an amount of fuel. The controller 52 executes control such as closing or opening a valve for adjusting the amount of fuel in accordance with the action determined by the action determination unit 108.

In the following description, the kinds of the observation (velocity, the number of rotations etc.) may be expressed as feature amounts and values observed regarding these kinds may be expressed as values of the feature amounts. The policy creation apparatus 100 acquires evaluation information indicating the level of the quality of the action that has been determined. The policy creation apparatus 100 selects a high-quality policy based on the acquired evaluation information. The evaluation information will be described later.

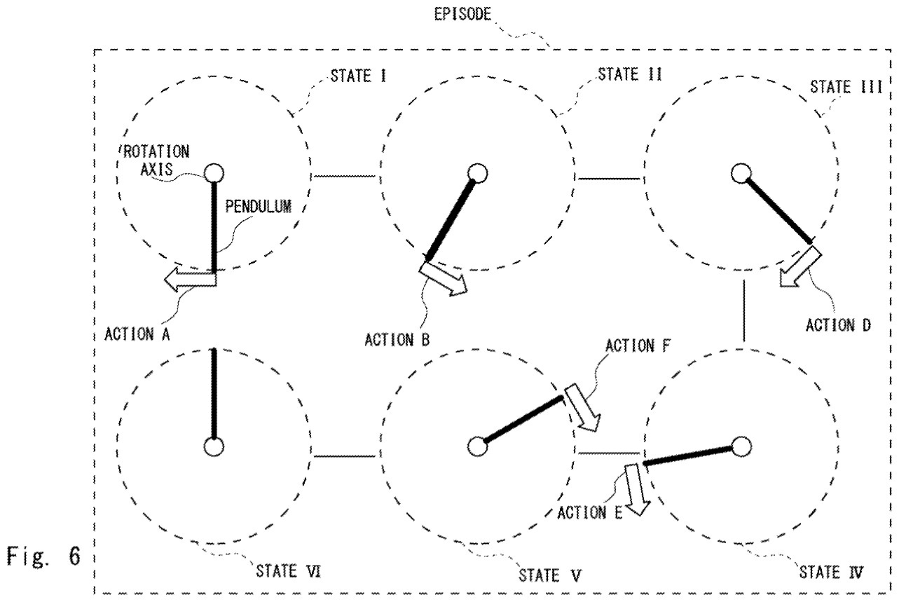

FIG. 6 is a diagram conceptually showing one example of the target 170 according to the first example embodiment. Referring next to FIG. 6, terms used herein will be described. The target 170 illustrated in FIG. 6 includes a rod-shaped pendulum and a rotation axis capable of applying torque to the pendulum. As state I indicates an initial state of the target 170 and the pendulum is present below the rotation axis. A state VI indicates an end state of the target 170, in which the pendulum is present above the rotation axis in an inverted state. Actions A to F indicate forces of applying torque to the pendulum. Further, states I to VI indicate states of the target 170. Further, regarding the state of the target 170, the respective states from the first state to the second state are collectively expressed by an “episode”. The episode may not necessarily indicate each state from the initial state to the end state and may indicate, for example, each state from a state II to a state III or each state from the state III to the state VI.

The policy creation apparatus 100 creates, for example, a policy for determining a series of actions that may achieve the state VI, starting from the state I (illustrated in FIG. 5) based on the action evaluation information regarding an action. The processing in which the policy creation apparatus 100 creates the policy will be described later with reference to FIG. 2 and the like. In the present example embodiment, the policy is represented in the form of a list, such as the decision list, so that it can be said that the policy has high visibility for a user.

Next, specific processing of each of the components of the policy creation apparatus 100 will be described using FIGS. 2 to 4.

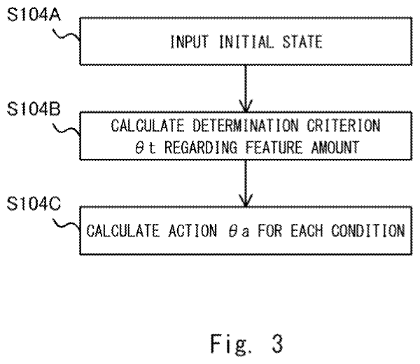

FIG. 2 is a flowchart showing a policy creation method executed by the policy creation apparatus 100. The rule creation unit 102 generates N rule parameter vectors θ (N is a predetermined integer equal to or larger than two) according to a predetermined rule creation criterion (Step S104). Specific processing in S104 will be described later with reference to FIG. 3.

The rule creation criterion may be a probability distribution such as uniform distribution, Gaussian distribution, and the like. The rule creation criterion may be a distribution based on parameters calculated by performing processing as described below. The rule parameter vector θ (rule parameter) can be a parameter representing a characteristic of the rule. The rule parameter vector θ (θ⁽¹⁾−θ⁽ⁿ⁾−θ^{(N)}) will be discussed later. Note that n is an index identifying each rule parameter vector (and the rule set described below), and is an integer from one to N. In the first processing of S104, parameters of the distribution (average, standard deviation and the like) may be any desired (e.g., random) values.

Next, the policy creation apparatus 100 initializes n (i.e., sets n=1) (Step S106). Then, the rule creation unit 102 creates the rule set #n from the rule parameter vector θ⁽ⁿ⁾ (Step S108). Thus, a rule is expressed by a set of rule parameters that follow a predetermined rule creation criterion. In the first processing of S108, n is set as n=1. Also, as described below, the rule set #n can be uniquely generated from the rule parameter vector Ow.

FIG. 7 is a diagram illustrating the rule set #n created by the rule creation unit 102 according to the first embodiment. The rule set #n is composed of I rules #1 to #I. In other words, a rule set includes a plurality of rules. As described above, each rule #i (where i is an integer from one to I) includes a condition in which the feature amount corresponding to the state comforts to the determination criterion and an action (control quantity) to be performed if the condition is met. In the example shown in FIG. 7, the condition is shown between “IF” and “THEN”. The action is shown to the right of “THEN”.

For example, in the example shown in FIG. 7, rule #1 corresponds to a rule “IF (feat_1>θt1) THEN action=θa1. This rule indicates that the action θa1 (the action corresponding to the parameter θa1) is taken regarding the target 170 when the feature amount feat_1 exceeds the determination criterion θt1. In rule #1, the condition is (feat 1>θt1). In rule #1, the action is (action=θa1).

Further, rule #2 corresponds to a rule “IF (feat_1>θt2 AND feat_2<θt3) THEN action=θa2”. This rule indicates that the action θa2 (the action corresponding to the parameter θa2) is taken regarding the target 170 when the feature amount feat_1 exceeds the determination criterion θt2 and the feature amount feat_2 is below the determination criterion θt3. In rule #2, the condition is (feat_1>θt2 AND feat_2<θt3). In rule #2, the action is (action=θa2).

In addition to the rules illustrated in FIG. 7, a rule, such as “IF (feat_3=θt4) THEN action=θa3” in which a condition is expressed not by a threshold but by a value itself or a determination of the state, may be included. Further, in this example embodiment, it is assumed that the feature amount (i.e., type of observation) to be determined is set in the rule set in advance. The types of observations set for feature amount in the rule set may be all types or some types. However, the rule creation unit 102 may set the feature amount using the probability distribution as described above. That is, the rules are not limited to the examples illustrated in FIG. 7. The action θa may be, for example, the value of an object to be controlled (control quantity, control value). For example, if the controlled object is the speed of the vehicle, the action θa may correspond to the speed value of the vehicle. In addition, when the controlled object is an inverted pendulum (FIG. 6), the action θa may correspond to the magnitude of the torque (force) applied to the pendulum.

As described above, the rule is represented by a combination of the condition for determining the state of an object (i.e., target) and the action in the state. In other words, the rule can also be represented by a combination of the condition for determining the necessity of the action to be taken regarding an object and the action to be performed if the condition holds.

The indices #1 to #I of the rules #1 to #I in the rule set #n do not indicate the order in which a conditional determination is made in the decision list, but are set arbitrarily. The order of rules #1 to #I in each rule set #n may be fixed. Thus, every rule set #n may include rules #1 to #I, in that order. Further, it is assumed that in all rule sets #n, the framework of each rule #i is fixed and only the determination criterion θt and the action θa are variable.

In other words, in each rule set #n, the included rules #1 to #I are the same except for the determination criterion θt and the action θa.

That is, it is assumed that the feature amount feat_m (m is an integer greater than or equal to two and is an index representing the feature amount) and the inequality sign for the feature amount are fixed for each of rule #1 to #I of all rule sets #n.

As described above, the rule creation unit 102 may set the feature amount using the probability distribution as described above.

In the example shown in FIG. 7, rule #1 regarding all rule sets #n includes a part of the condition “feature amount feat_1>”, but its determination criterion θt1 can be different for each rule set #n. Similarly, the action θa1 in rule #1 regarding all rule sets #n can be different for each rule set #n. Further, rule #2 regarding all rule sets #n includes a part of the condition “feature amount feat_1>” and “feat_2<”, but their determination criteria θt2 and θt3 can be different for each rule set #n. Similarly, the action θa2 in rule #2 regarding all rule sets #n can be different for each rule set #n.

Then, the rule parameter vector θ generated in the processing in S104 is a vector whose components are the variable parameters (rule parameters θt, θa) described above in rules #1 to #I. For example, the rule parameter vector θ is a vector whose components are the rule parameters θt and θa in order from rule #1. Therefore, the rule parameter vector θ (rule parameter) can be said to be a parameter representing a characteristic of a rule.

Further, in the example shown in FIG. 7, the rule parameter vector θ⁽ⁿ⁾ is expressed, for example, by the following Expression 1.

θ⁽ⁿ⁾=(θt1,θa1,θt2,θt3,θa2, . . . ) (Expression 1)

In the above Expression 1, “θt1, θa1” are components regarding rule #1 and “θt2, θt3, θa2” are components regarding rule #2. Note that as the number of rules I increases, the size (number of components) of the rule parameter vector θ also increases. Here, as mentioned above, the rule parameter can be generated by a distribution (probability distribution, etc.) such as a Gaussian distribution. Therefore, the rule creation unit 102 can create a rule in which condition and action are randomly combined.

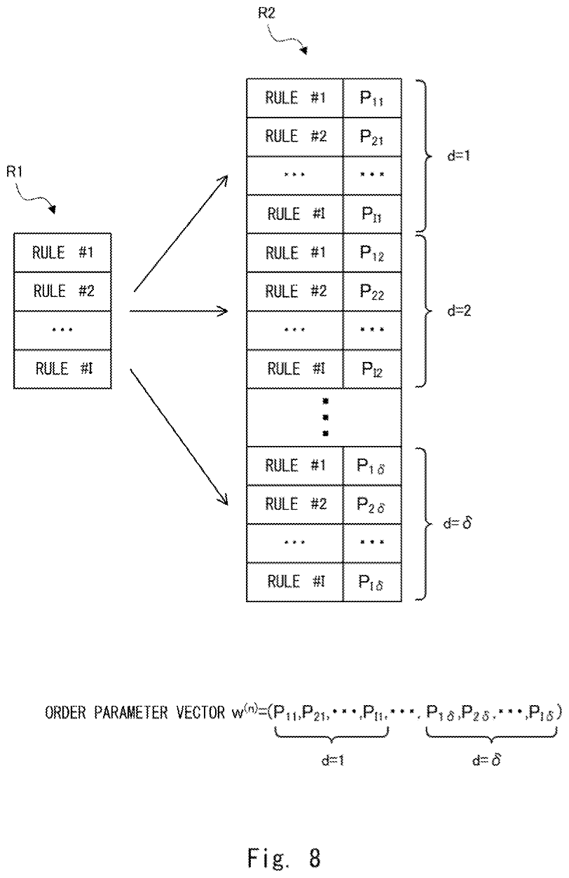

The order parameter calculation unit 104 calculates order parameters for each of rules #1 to #I using the rule parameter vector θ (Step S110). Specifically, the order parameter calculation unit 104 calculates, for each rule set #n, the order parameters using the corresponding rule parameter vector θ⁽ⁿ⁾. The order parameter is a parameter for determining the order, in the decision list #n, of the rules #1 to #I that constitute the rule set #n. The order parameter may also indicate a weight for each of rules #1 to #I. Then, the order parameter calculation unit 104 outputs an order parameter vector whose component is the order parameter for each of rules #1 to #I. The order parameter will be described later in the second example embodiment with reference to FIGS. 8 to 10.

For example, the order parameter calculation unit 104 calculates order parameters using a model such as a neural network (NN). That is, by inputting the rule parameter vector θ⁽ⁿ⁾ into the model such as the neural network, the order parameter calculation unit 104 calculates order parameters for determining the order of rules #1 to #I in the decision list #n corresponding to the rule set #n. Therefore, the order parameter calculation unit 104 functions as a function approximator that takes (receives) the rule parameter vector θ as input and outputs the order parameter. As described below, the model such as the neural network can be updated based on, for example, a loss function. In a case of reinforcement learning, the model may be updated based on rewards achieved by determining actions according to policies (that is, ordered rule set) determined based on the order parameters.

The order parameter calculation unit 104 may update the parameters (weights) of the neural network to maximize the reward. In a case of reinforcement learning, the loss function is, for example, a function in which the higher the reward is, the smaller the value is, and the lower the reward is, the larger the value is. For example, the order parameter calculation unit 104 determines the order parameter for each rule based on the parameter, and determines the order of the rules based on the determined order parameter. In other words, the order parameter calculation unit 104 determines the ordered rule (i.e., policy). The order parameter calculation unit 104 determines the action according to the determined policy and calculates the reward obtained (achieved) by the determined action. Then, the order parameter calculation unit 104 calculates a parameter when the difference between the desired reward and the calculated reward decreases. It can also be said that the order parameter calculation unit 104 calculates a parameter when the calculated reward increases. In other words, the order parameter calculation unit 104 evaluates the state of the target 170 after the action is taken regarding the target 170 according to the determined policy, and updates the parameter based on the evaluation result.

The order parameter calculation unit 104 may update the parameter, for example, by executing processing according to a procedure for calculating a parameter of a gradient descent method or the like. The order parameter calculation unit 104 calculates the value of a parameter when, for example, a loss function expressed in quadratic form is minimized. The loss function is a function in which the larger the quality of the action is, the smaller the value is, and the smaller the quality of the action is, the larger the value is. The loss function is a function in which the higher the reward is, the smaller the value is, and the lower the reward is, the larger the value is.

For example, the order parameter calculation unit 104 calculates the gradient of the loss function, and calculates the value of a parameter when the value of the loss function becomes small (or become minimal) along the gradient. The order parameter calculation unit 104 updates the model of the neural network by executing such processing. Accordingly, as the action determined for each policy is executed and the quality of the action is evaluated, the model in the order parameter calculation unit 104 can calculate order parameters such that the order of rules #1 to #I in the decision list becomes more suitable.

The order parameter calculation unit 104 may repeatedly execute the processing of updating the parameter.

The processing of updating parameters achieves the effect of improving the quality of order parameters when a rule set is created according to a certain rule parameter vector θ.

The order determination unit 106 determines the order of rules #1 to #I constituting the rule set #n based on the calculated order parameters (Step S120). Accordingly, the order determination unit 106 creates a decision list #n corresponding to the rule set #n in which the order of rules #1 to #I is determined. In other words, the order determination unit 106 creates the policy #n expressed by the decision list #n. Specifically, the order determination unit 106 determines the order of rules #1 to #I constituting the rule set #n, using the order parameter vector output by the order parameter calculation unit 104. Then, the order determination unit 106 generates the decision list #n by permutating the rules #1 to #I in the determined order. More detailed processing of the order determination unit 106 will be described later in the second example embodiment.

Next, the action determination unit 108 determines the action according to the policy (decision list) created by the order determination unit 106. In other words, the action determination unit 108 determines whether the condition in the rule holds and determines the action when the condition holds, according to the determined order. The policy evaluation unit 110 evaluates the quality of the policy based on the quality of the determined action (Step S130).

At this time, the policy evaluation information storage unit 126 stores the identifier #n indicating the policy and evaluation information indicating the quality of the policy in association with each other. For example, the identifier #1 indicating the policy #1 corresponding to the decision list #1 and the evaluation information are stored in association with each other.

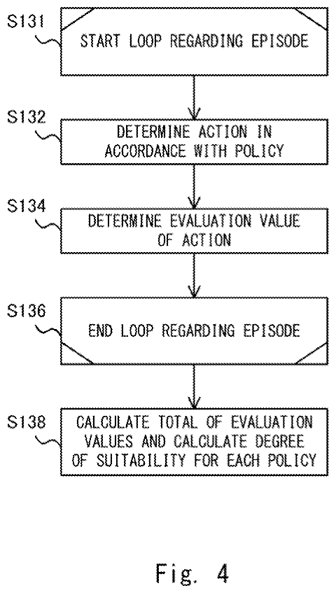

The policy evaluation unit 110 may calculate the degree of suitability (conformance) of each policy as the quality of the policy. The degree of suitability will be described later with reference to FIG. 4. The policy evaluation unit 110 evaluates the quality of each policy created by the order determination unit 106. In the processing in Step S130, the policy evaluation unit 110 may determine the quality of the action based on, for example, the quality of a state included in the episode described above with reference to FIG. 6. As described above with reference to FIG. 6, the action performed in one state may be associated with the next state in the target 170. Therefore, the policy evaluation unit 110 may use the quality of the state (next state) as the quality of the action that achieves this state (next state). In the example of the inverted pendulum as illustrated in FIG. 6, for example, the quality of the state may be expressed by a value indicating the difference between a target state (e.g., an end state; an inverted state) and the above state. The details of the processing in Step S130 will be described later in detail FIG. 4.

The policy creation apparatus 100 increments n by 1 (Step S142). Then, the policy creation apparatus 100 determines whether n exceeds N (Step S144). That is, the policy creation apparatus 100 determines whether a policy has been created for the rule sets #1 to #N for all the rule parameter vectors θ(1) to θ(N) respectively and the quality of each of the policies has been evaluated. If n does not exceed N, that is, the process is not completed for all policies (NO in S144), the process returns to S108 and the processes in S108 to S142 are repeated. In this way, the next policy is created and the quality of the policy is evaluated. On the other hand, if n exceeds N, that is, the process is completed for all policies (YES in S144), the process proceeds to S156.

The policy selection unit 120 selects high-quality policy (decision list) from among a plurality of policies based on the qualities evaluated by the policy evaluation unit 110 (Step S156). The policy selection unit 120 selects, for example, the policy (decision list) whose quality level (degree of suitability) is high from among the plurality of policies. Alternatively, the policy selection unit 120 selects, for example, the policy whose quality is equal to or higher than the average from among the plurality of policies. Alternatively, the policy selection unit 120 selects, for example, the policy whose quality is equal to or higher than a desired quality from among the plurality of policies. Alternatively, the policy selection unit 120 may select the policy whose quality is the highest from among the policies created in the iteration from Steps S108 to S154 (or S152). The processing of selecting policies is not limited to the above-described example.

Next, the criterion update unit 122 updates the rule creation criterion, which is a basis for creating the rule parameter vector θ in Step S104 (Step S158). The criterion update unit 122 may update the distribution (rule creation criteria), for example, by calculating the average and standard deviation of the parameter values for each of the parameters included in the policy selected by the policy selection unit 120. That is, the criterion update unit 122 updates, using the rule parameter indicating the policy selected by the policy selection unit 120, the distribution regarding the rule parameter. The criterion update unit 122 may update the distribution using, for example, a cross-entropy method.

The iteration processing from Step S102 (loop start) to Step S160 (loop end) is repeated, for example, a given number of times. Alternatively, this iteration processing may be repeated until the quality of the policy becomes equal to or larger than a predetermined criterion. By repeatedly executing the processing from Steps S102 to S160, the distribution that is a basis for creating the rule parameter vector θ tends to gradually approach a distribution in which observation values regarding the target 170 are reflected. Therefore, the policy creation apparatus 100 according to this example embodiment can create the policy in accordance with the target 170.

The action determination unit 108 may receive observation values indicating the state of the target 170 and determines the action to be taken regarding the target 170 in accordance with the input observation values and the policy whose quality is the highest. The controller 52 may further control the action to be taken regarding the target 170 in accordance with the action determined by the action determination unit 108.

Next, the processing of generating the rule parameter vector θ (S104 in FIG. 2) will be described using FIG. 3.

FIG. 3 is a flowchart showing the processing of the rule creation unit 102 according to the first example embodiment. The rule creation unit 102 receives the rule parameter vector θ in the initial state in which the values of the rule parameters θt and θa are not input in FIG. 7 (Step S104A). Here, since the framework of rules #1 to #I in each rule list is fixed as described above, it is predetermined which value is input in each of the components in the rule parameter vector θ and it is predetermined of which rule the value is input in each of the components in the rule parameter vector θ.

Next, the rule creation unit 102 calculates a determination criterion θt regarding the feature amount, using the rule creation criterion (Step S104B). Moreover, the rule creation unit 102 calculates the action θa for each condition using the rule creation criterion (Step S104C). The rule creation unit 102 may determine at least one of the condition and action in the rule in accordance with the rule creation criterion. Furthermore, at least some of the types of observations among a plurality of the types of observations regarding the target 170 may be set in advance as feature amounts. This processing eliminates the need to perform processing to determine the feature amount, and thus achieves the effect of reducing the amount of processing of the rule creation unit 102.

Specifically, the rule creation unit 102 provides the values of the rule determination parameter Θ for determining the rule parameters (determination criterion θt and action θa) in accordance with a certain distribution (e.g., probability distribution). The distribution that the rule determination parameters follow may be, for example, a Gaussian distribution. Alternatively, the distribution that the rule determination parameters follow may not be necessarily a Gaussian distribution, and may instead be other distributions such as a uniform distribution, a binomial distribution, or a multinomial distribution. Further, the distributions regarding the rule determination parameters may not be the same distribution and may be distributions different from one another for each rule determination parameter. For example, the distribution (rule creation criterion) that the parameter Θₜ for determining the determination criterion θt follows and the distribution (rule creation criterion) that the parameter Θₐ for determining the action θa follows may be different from each other. Alternatively, the distributions regarding the respective rule determination parameters may be distributions whose average values and standard deviations are different from each other. That is, the distribution is not limited to the above-described examples.

It is assumed, in the following description, that each rule determination parameter (rule parameter) follows a Gaussian distribution.

Next, processing of calculating the values of the respective rule determination parameters (rule parameters) in accordance with one distribution will be described. For the sake of convenience of description, it is assumed that the distribution regarding one rule determination parameter is a Gaussian distribution with average μ and standard deviation σ, where μ denotes a real number and σ denotes a positive real number. Further, μ and σ may be different for each rule determination parameter or may be the same.

The rule creation unit 102 calculates values of the rule determination parameters (rule determination parameter values) in accordance with the Gaussian distribution in the processing of S104B and S104C described above. The rule creation unit 102 randomly creates, for example, one set of rule determination parameter values (Θₜ and Θₐ) in accordance with the above Gaussian distribution. The rule creation unit 102 calculates, for example, the rule determination parameter values, using random numbers or pseudo random numbers using a random number seed, in such a way that the rule determination parameter values follow the Gaussian distribution. In other words, the rule creation unit 102 calculates the random numbers that follow the Gaussian distribution as values of the rule determination parameters. As described above, by expressing the rule set by the rule determination parameters that follow a predetermined distribution and by calculating the respective rule determination parameters in accordance with the distribution, the rules in the rule set (determination criterion θt and action θa) are determined. By permutating these rules, the decision list (policy) can be expressed more efficiently. Instead of the rule parameter vector θ, a rule determination parameter vector whose components are Θ may be used as an input to the order parameter calculation unit 104. Therefore, a rule determination parameter (rule determination parameter vector) can be said to be a kind of rule parameter (rule parameter vector).

The rule creation unit 102 calculates the determination criterion θt (S104B). Specifically, the rule creation unit 102 calculates a rule determination parameter Θₜ for determining the determination criterion θt.

At this time, the rule creation unit 102 may calculate a plurality of the determination criterion θt (rule determination parameter Θt regarding θt) such as θt1 and θt2 shown in FIG. 7 so that they follow Gaussian distributions different from one another (i.e., Gaussian distributions in which at least one of average values and standard deviations is different from one another). Therefore, the distribution that θt1 follows can be different from the distribution that θt2 follows.

The rule creation unit 102 calculates a determination criterion θt regarding the feature amount by executing the processing shown in the following Expression 2 for the calculated value Θₜ.

θt=(Vₘₐₓ−Vₘᵢₙ)×g(Θₜ)+Vₘᵢₙ (Expression 2)

The symbol Vₘᵢₙ indicates the minimum of the values observed for the feature amount. The symbol Vₘₐₓ indicates the maximum of the values observed for the feature amount. The symbol g (x), which is a function that gives a value from 0 to 1 to a real number x, indicates a function that monotonically changes. The symbol g (x), which is also called an activation function, is implemented, for example, by a sigmoid function.

Therefore, the rule creation unit 102 calculates the value of the parameter Θₜ in accordance with a distribution such as a Gaussian distribution. Then, as shown in Expression 2, the rule creation unit 102 calculates the determination criterion θt (e.g., threshold) regarding the feature amount from a range of observation values regarding the feature amount (in this example, a range from Vₘᵢₙ to Vₘₐₓ), using the value of the parameter Θₜ.

Next, the rule creation unit 102 calculates the action θa (state) for each condition (rule) (Step S104C). In some cases actions are indicated by continuous values, while in the other cases the actions are indicated by discrete values. When actions are indicated by continuous values, the values θa indicating the actions may be control values of the target 170. When, for example, the target 170 is the inverted pendulum shown in FIG. 6, the values may be torque values or angles of the pendulum. On the other hand, when the actions are indicated by discrete values, the values θa indicating the actions may be values that correspond to the kinds of the actions.

First, processing when the actions (states) are indicated by continuous values will be described.

The rule creation unit 102 calculates, regarding one action θa, a value Θₐ that follows a distribution such as a Gaussian distribution (probability distribution). At this time, the rule creation unit 102 may calculate a plurality of the actions θa (rule determination parameter Θₐ regarding θa) such as θa1 and θa2 shown in FIG. 7 so that they follow Gaussian distributions different from one another (i.e., Gaussian distributions in which at least one of average values and standard deviations is different from one another). Therefore, the distribution that θa1 follows can be different from the distribution that θa2 follows.

The rule creation unit 102 calculates an action value θa indicating an action regarding a certain condition (rule) by executing the processing shown in the following Expression 3 for the calculated value Θₐ.

θa=(Uₘₐₓ−Uₘᵢₙ)×h(Θₐ)+Uₘᵢₙ (Expression 3)

The symbol Uₘᵢₙ indicates the minimum of a value indicating an action (state). The symbol Uₘₐₓ indicates the maximum of a value indicating an action (state). The symbols Uₘᵢₙ and Uₘₐₓ may be, for example, determined in advance by the user. The symbol h(x), which is a function that gives a value from 0 to 1 for a real number x, indicates a function that monotonically changes. The symbol h(x), which is also called an activation function, may be implemented by a sigmoid function.

Therefore, the rule creation unit 102 calculates the value of the parameter Θₐ in accordance with a distribution such as a Gaussian distribution. Then as shown by Expression 3, the rule creation unit 102 calculates one action value θa indicating the action in a certain rule from a range of observation values (in this example, a range from Uₘᵢₙ to Uₘₐₓ) using the value of the parameter Θₐ. The rule creation unit 102 executes the above processing regarding each of the actions.

Note that the rule creation unit 102 may not use a predetermined value for “Uₘₐₓ−Uₘᵢₙ” in the above Expression 3. The rule creation unit 102 may determine the maximum action value to be Uₘₐₓ and determine the minimum action value to be Uₘᵢₙ from the history of action values regarding the action. Alternatively, when the actions are each defined by a “state”, the rule creation unit 102 may determine a range of values (state values) indicating the next state in the rule from the maximum value and the minimum value in the history of observation values indicating each state. According to the above processing, the rule creation unit 102 may efficiently determine the action included in the rule for determining the state of the target 170.

Next, processing when the actions (states) are indicated by discrete values will be described. It is assumed, for the sake of convenience of description, that there are A kinds of actions (states) regarding the target 170 (where A is a natural number). That is, it means that there are A kinds of action candidates for a certain rule. The rule creation unit 102 calculates the values of (the number of rules I×A) parameters Θₐ so that they each follow a distribution such as a Gaussian distribution (probability distribution). The rule creation unit 102 may calculate each of (I×A) parameters Θₐ so that they respectively follow Gaussian distributions different from one another (i.e., Gaussian distributions in which at least one of average values and standard deviations is different from one another).

The rule creation unit 102 checks A parameters that correspond to one rule from the parameters Θₐ when the action in one rule is determined. Then the rule creation unit 102 determines the action (state) that corresponds to a certain rule, e.g., a rule that the largest value is selected, from among the parameter values that correspond to this action (state). When, for example, the value of Θₐ^{(1,2)} is the largest in the parameters Θₐ^{(1,1)}−Θₐ^{(1,A)} of the rule #1, the rule creation unit 102 determines the action that corresponds to Θₐ^{(1,2)} as the action in the rule #1.

As a result of the processing in Steps S104A to S104C shown in FIG. 3, the rule creation unit 102 creates one rule parameter vector θ (rule set). The rule creation unit 102 creates a plurality of rule parameter vectors θ (rule sets) by repeatedly executing this processing. Since the rule parameters are randomly calculated in accordance with a distribution such as a Gaussian distribution (probability distribution), in each of a plurality of rule sets, values of the rule parameters may vary. That is, the rule creation unit 102 creates a rule in which conditions and actions are randomly combined. Thus, a plurality of different rule sets may be created efficiently. Since the bias of the rule can be reduced by the processing of creating a rule in which conditions and actions are randomly combined, for example, the control apparatus 50 achieves the effect of accurately controlling the action of the target 170.

Using next to FIG. 4, the processing in which the policy evaluation unit 110 evaluates the qualities of the policies (S130 in FIG. 2) will be described. FIG. 4 is a flowchart showing a flow of processing in the policy evaluation unit 110 according to the first example embodiment. The processing shown in the flowchart in FIG. 4 is executed for each of the plurality of policies (decision lists) that have been created.

The action determination unit 108 acquires observation values (state values) observed regarding the target 170. The action determination unit 108 then determines an action in this state for the acquired observation values (state values) in accordance with one of the policies created by the processing of S120 shown in FIG. 2 (Step S132). That is, the action determination unit 108 determines the control value for controlling the action of the target 170 by using the state of the target 170 and the created policy, and gives instructions to execute the action in accordance with the determined control value.

Next, the action evaluation unit 112 determines the evaluation value of the action by receiving evaluation information indicating the evaluation value regarding the action determined by the action determination unit 108 (Step S134). The action evaluation unit 112 may determine the evaluation value of the action by creating the evaluation value regarding the action in accordance with the difference between a desired state and a state that is caused by this action. In this case, the action evaluation unit 112 creates, for example, an evaluation value indicating that the quality regarding the action becomes lower as this difference becomes larger and the quality regarding the action becomes higher as this difference becomes smaller. Then the action evaluation unit 112 determines, regarding an episode including a plurality of states, the qualities of the actions that achieve the respective states (the loop shown in Steps S131 to S136).

Next, the comprehensive evaluation unit 114 calculates the total value of the evaluation values regarding each of the actions. Specifically, the comprehensive evaluation unit 114 calculates the degree of suitability regarding this policy by calculating the total value for a series of actions determined in accordance with this policy (Step S138). Accordingly, the comprehensive evaluation unit 114 calculates the degree of suitability (evaluation value) regarding the policy for one episode.

The comprehensive evaluation unit 114 may create evaluation information in which the degree of suitability calculated regarding the policy (i.e., quality of the policy) is associated with the identifier indicating this policy and store the created policy evaluation information in the policy evaluation information storage unit 126.

Note that the policy evaluation unit 110 may calculate the degree of suitability (evaluation value) of the policy by executing the processing illustrated in FIG. 4 for each of the plurality of episodes and calculating the average value thereof. Further, the action determination unit 108 may first determine the action that achieves the next state. Specifically, the action determination unit 108 may first obtain all the actions included in the episode in accordance with the policy and the action evaluation unit 112 may execute processing for determining the evaluation value of a state included in this episode.

With reference to a specific example, the processing shown in FIG. 4 will be described. It is assumed that one episode is composed of 200 steps (i.e., 201 states) for the sake of convenience of the description. It is further assumed that, for each step, the evaluation value is (+1) when the action in the state of each step is fine and the evaluation value is (−1) when the action in the state of each step is not fine. In this case, when an action has been determined in accordance with a policy, the evaluation value (degree of suitability) regarding this policy is a value from −200 to 200. Whether or not the action is fine may be determined, for example, based on the difference between a desired state and the state reached by the action. That is, it may be determined that the action is fine when the difference between the desired state and the state reached by the action is equal to or smaller than a predetermined threshold. In the following description, for the sake of convenience of the description, it is assumed that the quality of the policy becomes higher as the value of the evaluation information becomes larger, and the quality of the policy becomes lower as the value of the evaluation information becomes smaller.

The action determination unit 108 determines an action that corresponds to a state in accordance with one policy, which is the evaluation target. The action determination unit 108 instructs the controller 52 to execute the determined action. The controller 52 executes the determined action. Next, the action evaluation unit 112 calculates the evaluation value regarding the action determined by the action determination unit 108. The action evaluation unit 112 calculates, for example, the evaluation value (+1) when the action is fine and the evaluation value (−1) when it is not fine. The action evaluation unit 112 calculates the evaluation value for each action in one episode that includes 200 steps.

In the policy evaluation unit 110, the comprehensive evaluation unit 114 calculates the degree of suitability regarding the one policy by calculating the total value of the evaluation values calculated for the respective steps. It is assumed, for example, the policy evaluation unit 110 has calculated the degrees of suitability as follows regarding the policies #1 to #4.
policy #1: 200
policy #2: −200
policy #3: −40
policy #4: 100

In this case, when, for example, the policy selection unit 120 selects two of the four policies whose evaluation values calculated by the policy evaluation unit 110 are within top 50%, the policy selection unit 120 selects the policies #1 and #4 whose evaluation values are larger than those of the others. That is, the policy selection unit 120 selects high-quality policies from among a plurality of policies (S156 in FIG. 2).

The criterion update unit 122 calculates, regarding each of the rule parameters included in the high-quality policies selected by the policy selection unit 120, the average of the parameter values and standard deviation thereof. The criterion update unit 122 thereby updates a distribution such as a Gaussian distribution (rule creation criterion) that each rule parameter follows (S158 in FIG. 2). Then the processing shown in FIG. 2 is performed again using the updated distribution. That is, the rule creation unit 102 executes the processing shown in FIG. 8 using the updated distribution and creates a plurality of (N) new rule parameter vectors θ and rule sets. Then the action determination unit 108 determines, for each of the plurality of policies newly created by using rule parameter vectors θ that have been created again, the action in accordance with the policy. Then the policy evaluation unit 110 determines, for each of the plurality of policies that have been created again, the evaluation value (degree of suitability).

As described above, since the distribution is updated using high-quality policies, the average value μ in the distribution that the rule parameters follow may approach a value that may achieve policies with higher qualities. Further, the standard deviation σ in the distribution that the rule parameters follow may become smaller. Therefore, the width of the distribution may become narrower as the number of times of update increases. Accordingly, the rule creation unit 102 is more likely to calculate rule parameters that correspond to policies with higher evaluation values (higher qualities) by using the updated distribution. In other words, the rule creation unit 102 calculates the rule parameters using the updated distribution and the policy (decision list) is created by using the order parameter calculated by using the rule parameter, which increase the probability that high-quality policies will be created. Therefore, by repeating the processing as shown in FIG. 2, the evaluation values of the policies may be improved. Then, by repeating the above processing a predetermined number of times, for example, the policy whose evaluation value becomes the largest may be determined as a policy regarding the target 170 among the plurality of obtained policies. Accordingly, high-quality policies may be obtained.

Note that the action determination unit 108 may specify the identifier indicating the policy having the largest evaluation value (i.e., the highest quality) from the policy evaluation information stored in the policy evaluation information storage unit 126 and determine the action in accordance with the policy indicated by the specified identifier. That is, when newly creating a plurality of policies, the rule creation unit 102 may, for example, create (N−1) policies using the updated distribution and set the remaining one policy as a policy whose evaluation value is the largest among the policies created in the past. Then the action determination unit 108 may determine actions for (N−1) policies created using the updated distribution and the policy whose evaluation value is the largest among the polices created in the past. According to the above processing, when a policy whose evaluation value has been previously high is still evaluated relatively highly even after the distribution is updated, this policy can be appropriately selected. Therefore, it becomes possible to create high-quality policies more efficiently.

In the example of the inverted pendulum illustrated in FIG. 6, the determination regarding whether or not an action is fine may be performed based on the difference between the state caused by the action and the state VI in which the pendulum is inverted. When it is assumed, for example, that the state caused by the state is a state III, it may be determined whether or not the action is fine based on the angle formed by the direction of the pendulum in the state VI and the direction of the pendulum in the state III.

Further, in the aforementioned examples, the policy evaluation unit 110 evaluates each policy based on each of the states included in an episode. Instead, this policy may be evaluated by predicting a state that may reach in the future by execution of an action and calculating the difference between the predicted state and a desired state. In other words, the policy evaluation unit 110 may evaluate the policy based on the estimated value (or the expected value) of the evaluation value regarding the state determined by executing the action. Further, the policy evaluation unit 110 may calculate, regarding one policy, evaluation values of a policy regarding each episode by iteratively executing the processing shown in FIG. 4 using a plurality of episodes and calculate, as the degree of suitability, the average value (median value etc.) thereof. That is, the processing executed by the policy evaluation unit 110 is not limited to the aforementioned examples.

Next, effects (i.e., technical advantages) regarding the policy creation apparatus 100 according to the first example embodiment will be described. With the policy creation apparatus 100 according to the first example embodiment, policies with high quality and high visibility can be created. The reason therefor is that the policy creation apparatus 100 creates policies each configurated by the decision list including a predetermined number of rules so that these policies conform to the target 170.

Further, according to the policy creation apparatus 100 according to this example embodiment, the order parameter calculation unit 104 is configured to calculate the order parameter, and the order determination unit 106 is configured to determine the order of the rules in the rule set according to the order parameter. Accordingly, it is possible to create a decision list (policy) in which the order of the rules is properly determined.

Furthermore, according to the policy creation apparatus 100 according to this example embodiment, the rule creation unit 102 is configured to calculate the value of the rule parameter in accordance with the rule creation criterion, and the order parameter calculation unit 104 is configured to calculate the order parameter according to the rule parameter. Here, as mentioned above, a rule parameter can be a parameter indicating a characteristic of the rule. Thus, the order parameter calculation unit 104 can calculate the order parameter according to the characteristic of the rule, so that the decision list with the order according to the characteristic of the rule can be created.

Furthermore, according to the policy creation apparatus 100 according to this example embodiment, the order parameter calculation unit 104 updates the model so that the quality of the action is maximized (or so that the quality of action increases). Accordingly, the policy creation apparatus 100 (order determination unit 106) can more reliably create a decision list that can realize high quality.

While the processing in the policy creation apparatus 100 has been described using the term “state of the target 170”, the state may not necessarily be an actual state of the target 170. The state may be, for example, information indicating the result of calculation performed by a simulator that has simulated the state of the target 170. In this case, the controller 52 may be achieved by the simulator.

### Second Example Embodiment

Next, a second example embodiment will be described. In the second example embodiment, details of the processing of the order parameter calculation unit 104 described above will be described.

The order parameter calculation unit 104 generates a list in which rules are associated with order parameters indicating the degree of appearance of the rules. The order parameter is a value that indicates the degree to which each rule appears at a particular position in the decision list. The order parameter calculation unit 104 according to this example embodiment generates a list in which each rule included in a set of received rules is allocated to a plurality of positions on the decision list with an order parameter indicating the degree of appearance. In the following description, for the sake of convenience of description, the order parameter is treated as the probability of a rule appearing on the decision list (hereafter, it is referred to as the appearance probability). Therefore, the generated list is hereinafter referred to as the probabilistic decision list. The probabilistic decision list is described later with reference to FIG. 8.

The method by which the order parameter calculation unit 104 allocates rules to a plurality of positions on the decision list is arbitrary. However, in order for the order parameter calculation unit 104 to appropriately update the order of the rules on the decision list, it is preferable to allocate the rules so as to cover the anteroposterior relationship of each of the rules. Therefore, when the first rule and the second rule are allocated, for example, the order parameter calculation unit 104 preferably allocates the second rule after the first rule and allocates the first rule after the second rule. The number of rules allocated by the order parameter calculation unit 104 may be the same or different in each rule.

The order parameter calculation unit 104 may also generate a probabilistic decision list of length δ|I| by duplicating the rule set R (rule set #n) including I rules so that the number of it becomes δ and connecting the duplicated rule sets. By duplicating the same rule set to generate a probabilistic decision list in this way, the update processing of the order parameters by the order parameter calculation unit 104, which will be described later, can be made efficient.

In the case of the example described above, rule #j appears a total of δ times in the probabilistic decision list, and its appearance positions are expressed in Expression 4, illustrated below. Note that the symbol j is an integer from 1 to I.

π(j,d)=(d−1)*|I|+j(d∈[1,δ]) (Expression 4)

The order parameter calculation unit 104 may calculate the probability p_{π(j,d) in which rule #j appears at position π(j,d) by using a Softmax function with temperature illustrated in the following Expression} 5, as an order parameter. In Expression 5, the symbol τ is a temperature parameter and the symbol W_{j,d} is a parameter indicating the degree (weight) to which rule #j appears at position π(j,d) in the list. The symbol d is an index indicating the appearance position (hierarchy) of rule #j in the probabilistic decision list.

$${p}_{π ( j , d )} = \frac{exp ( {W}_{j , d} / τ )}{{\sum }_{{d}^{′} = 1}^{δ} exp ( {W}_{j , {d}^{′}} / τ )} \qquad ( Expression 5 )$$

In this way, the order parameter calculation unit 104 may generate a probabilistic decision list in which each rule is allocated to a plurality of positions on the decision list with the appearance probability defined by the Softmax function illustrated in Expression 5. Also, in above Expression 5, the parameter W_{j,d} is any real number in the range of [−∞, ∞]. However, the probabilities p_{j,d} are normalized so that the sum of them is 1 by the Softmax function. That is, for each rule #n, the sum of the appearance probabilities at δ positions in the probabilistic decision list is 1. Further, in Expression 5, when the temperature parameter τ approaches zero, the output of the Softmax function approaches the one-hot vector. That is, in one rule #j, a probability only at any one position among positions in which d takes 1 to δ is one and probabilities at other positions are zero. Therefore, the order parameter calculation unit 104 according to this example embodiment determines the order parameter so that the sum of the order parameters of the same rules allocated to a plurality of positions becomes 1.

FIG. 8 is a diagram for describing an example of processing for generating a probabilistic decision list calculated by the order parameter calculation unit 104 according to the second example embodiment. The order parameter calculation unit 104 receives a rule parameter vector θ⁽ⁿ⁾ constituting rules #1 to #I. Accordingly, the order parameter calculation unit 104 generates the rule set #n (R1). Furthermore, the order parameter calculation unit 104 generates a probabilistic decision list #n (R2) including the δ rule sets #n obtained by duplicating the rule set #n.

Furthermore, the order parameter calculation unit 104 calculates the order parameter P_{jd} corresponding to each rule #(J,d) included in the probabilistic decision list R2 by using the model such as the neural network described above. Accordingly, the order parameter calculation unit 104 calculates an order parameter vector w⁽ⁿ⁾ in which the number of components is I×δ as shown in the following Expression 6.

w⁽ⁿ⁾=(P₁₁,P₂₁, . . . ,P₁₁, . . . ,P_{1δ},P_{2δ}, . . . ,P_{1δ}) (Expression 6)

In above Expression 6, “P₁₁ to P_{I1}” are components regarding the hierarchy of d=1 and “P_{1δ} to P_{1δ}” are components regarding the hierarchy of d=δ. Further, for each rule #j, the sum of the order parameters in which d takes 1 to δ is 1. Thus, for each rule #j, Σ_{d=1}^{δ}(P_{jd})=1 holds. For example, P₁₁+P₁₂+ . . . +P_{1δ}=1 holds and P₂₁+P₂₂+ . . . +P_{2δ}=1 holds.

Then, the order parameter calculation unit 104 associates the calculated order parameter P_{jd} with each rule #(j,d). For example, in the example shown in FIG. 8, the order parameter calculation unit 104 associates the order parameter P₁₁ with rule #1 at d=1 (i.e., rule #(1,1)). In this way, the order parameter calculation unit 104 generates the probabilistic decision list.

The action determination unit 108 determines an action using the probabilistic decision list. When the action in the state is determined, the action determination unit 108 may determine the action for the highest rule conforming to the condition in the probabilistic decision list, as the action to be executed.

Alternatively, the action determination unit 108 may determine the action to be executed in consideration of the action for the lower rules in the probabilistic decision list. In this case, the action determination unit 108 extracts all rules that have conditions conforming to the state from among rules #1 to #I. Then, the action determination unit 108 sums up (i.e., integrates) the actions, after performing weighting such that the weight of the subsequent rule becomes less than the weight of the higher-order rule by the weighted linear sum. The sum (i.e., integration) of these actions is referred to as “integrated action”.

In the second example embodiment, it is assumed that the actions included in each rule corresponds to the same control parameters as each other. For example, if the target 170 is an inverted pendulum, the actions may be “torque value” for all rules. Further, if the target 170 is a vehicle, the actions may be “vehicle speed” for all rules.

For example, in the examples shown in FIG. 7 and FIG. 8, if δ=2 holds and the state conforms to the conditions of rule #1 and rule #2, the action determination unit 108 determines the integrated action as following Expression 7.

$$Integrated action = θ a 1 * {P}_{11} + θ a 2 * \{ ( 1 - {P}_{11} ) * {P}_{21} \} + θ a 1 * \{ ( 1 - {P}_{11} ) * ( 1 - {P}_{21} ) * {P}_{12} \} + θ a 2 * \{ ( 1 - {P}_{11} ) * ( 1 - {P}_{21} ) * ( 1 - {P}_{12} ) * {P}_{22} \} \qquad ( Expression 7 )$$

The policy evaluation unit 110 acquires a reward (evaluation value) for the state realized (obtained) by the integrated action for each state. Accordingly, for each rule parameter vector θ, the reward for each integrated action is acquired. The policy evaluation unit 110 outputs the reward of the integration action to the order parameter calculation unit 104 for each rule parameter vector.

The order parameter calculation unit 104 updates the model so that the reward acquired by the determined action (or, integrated action) is maximized (or so that the reward increases). Accordingly, the order parameters (weights) of the rules become updated. Thus, in a rule that is easy to conform to the state, the corresponding order parameter may become higher in a higher hierarchy d, and in a rule that is hard to conform to the state, the corresponding order parameter may become higher in a lower hierarchy d. Furthermore, as the model is updated, the values of the order parameters of rules with characteristics similar to each other can become closer to each other.

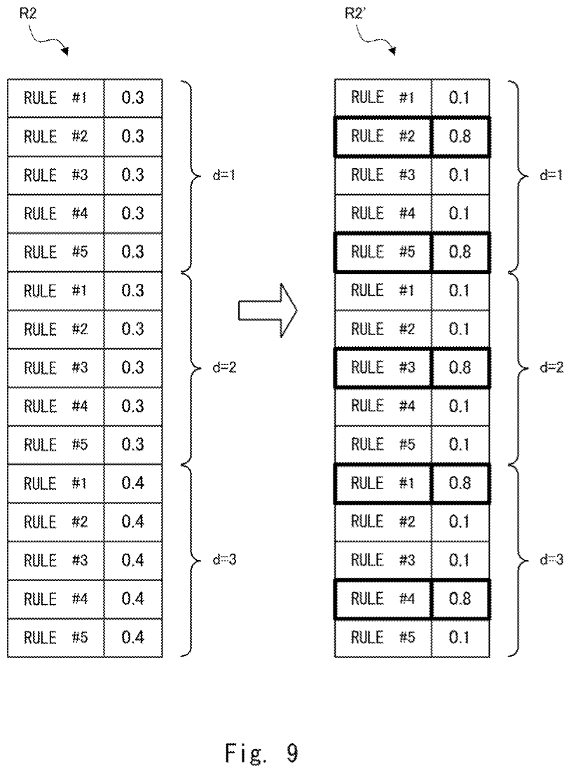

FIG. 9 is a diagram for describing the updating of the order parameters, according to the second example embodiment. In FIG. 9, it is assumed that δ=3 and I=5 hold. Further, it is assumed that, in the initial state, the probabilistic decision list R2 is established so that the order parameters of all the rules in the hierarchies d=1 and d=2 are 0.3 and the order parameters of all the rules in the hierarchy d=3 is 0.4. By the update processing of the order parameter calculation unit 104, in the updated probabilistic decision list R2′, the order parameters of rules #2 and #5 in the hierarchy d=1 have been updated to 0.8. Similarly, the order parameter of rule #3 in hierarchy d=2 has been updated to 0.8, and the order parameters of rules #1 and #4 in hierarchy d=3 have been updated to 0.8. And other order parameters have been updated to 0.1. That is, it can be seen that rules #2 and #5 which have high values of the order parameters in the upper hierarchy have high suitability, and rules #1 and #4 which have high values of the order parameters in the lower hierarchy have low suitability.

The order determination unit 106 determines the order of the rules using the updated probabilistic decision list. Accordingly, the order determination unit 106 generates a candidate of the decision list. Therefore, the order determination unit 106 creates a candidate of the policy. Specifically, the order determination unit 106 extracts, for each of the rules, the rule from the hierarchy with the largest value of the order parameter. Then, the order determination unit 106 arranges the extracted rules in order from the upper hierarchy. Thus, the order determination unit 106 generates a decision list in which each rule is ordered.

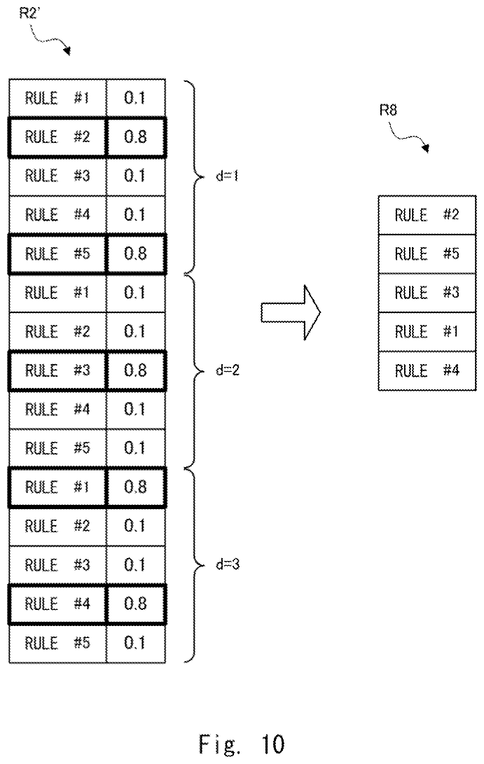

FIG. 10 is a diagram for describing the processing of generating the decision list by the order determination unit 106 according to the second example embodiment. The order determination unit 106 extracts rules #2 and #5 from the hierarchy d=1 in the updated probabilistic decision list R2′. Similarly, the order determination unit 106 extracts rule #3 from the hierarchy d=2. The order determination unit 106 extracts rules #1 and #4 from the hierarchy d=3. Then, the order determination unit 106 arranges the extracted rules in order from the hierarchy d=1. As a result of it, a decision list R8 in which rule #2, rule #5, rule #3, rule #1 and rule #4 is arranged in this order.

Here, the processing flow of the policy creation apparatus 100 according to the second example embodiment will be described with reference to FIG. 2. The processing of S104 to S108 is substantially the same as that in the first example embodiment.

Next, in the processing of S110, as described above, the order parameter calculation unit 104 duplicates the rule set to generate the probabilistic decision list. Then, as described above, the order parameter calculation unit 104 calculates the order parameters corresponding to the respective rules included in the probabilistic decision list, using the model. Then, the order parameter calculation unit 104 determines the order to which the rules are applied based on the calculated order parameters, and determines the action to be performed according to the determined order. Alternatively, the order parameter calculation unit 104 determines the integrated action based on the calculated order parameters and the probabilistic decision list. The order parameter calculation unit 104 calculates a reward obtained by the determined action (or the integrated action), and updates the parameters in the model using the calculated reward. The order parameter calculation unit 104 may repeatedly execute the processing of updating the parameters. The order parameter calculation unit 104 creates a plurality of the decision lists (i.e., policies).

Next, in the processing of S130, as described above, the action determination unit 108 determines the action according to the determined policy and state. Then, the policy evaluation unit 110 evaluates the quality of the action for each state to acquire an evaluation value. Then, the policy creation apparatus 100 updates the rule creation criterion by using the policy with the high evaluation value (S156, S158).

As described above, in this example embodiment, the order parameter calculation unit 104 allocates the respective rules included in a set of rules to a plurality of positions on the decision list with order parameters. Further, the order parameter calculation unit 104 updates the parameters for determining the order parameters so that the reward realized by the action for the rule whose state satisfies the condition is maximized (or so that the reward increases). Here, a large amount of processing is needed to optimize the order of rules in the decision list. On the other hand, in this example embodiment, the amount of processing in the processing of creating the decision list can be reduced by the above processing.

Although a normal decision list is discrete and indifferentiable, the probabilistic decision list is continuous and differentiable. In this example embodiment, the order parameter calculation unit 104 generates the probabilistic decision list by allocating the respective rules to a plurality of positions on the list, with order parameters. The generated probabilistic decision list is a decision list in which the rules exist probabilistically by regarding that the rules are probabilistically distributed, and can be optimized by the gradient descent method. This reduces the amount of processing in creating more accurate decision lists.

In the policy creation apparatus 100 according to this example embodiment, the order parameter calculation unit 104 is configured to calculate the order parameter for determining an order in the decision list using the rule parameter vector. Thus, even if the rule parameters are changed (updated) by updating the distribution, the update of the model can be stably performed in the order parameter calculation unit 104. That is, the framework of the rule set is immutable. Further, the order parameter calculation unit 104 calculates the order parameters from the rule parameters, and the decision list is determined from the order parameters. Thus, the update of the model (gradient learning) can be stably performed. Therefore, as the iteration of the loop in FIG. 2 progresses, the rule set (rule parameter vector) and the order of the rules will become more appropriately optimized.

### Third Example Embodiment

Next, a third example embodiment will be described.

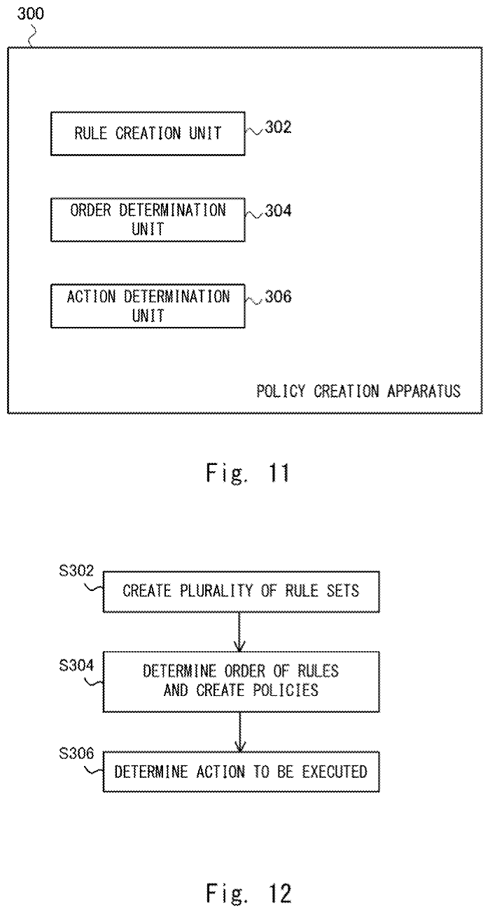

FIG. 11 is a diagram showing a configuration of the policy creation apparatus 300 according to the third example embodiment. The policy creation apparatus 300 according to the third example embodiment includes a rule creation unit 302, an order determination unit 304, and an action determination unit 306. The rule creation unit 302 includes a function as rule creation means. The order determination unit 304 includes a function as order determination means. The action determination unit 306 includes a function as action determination means. The rule creation unit 302 may be achieved by functions similar to those included in the rule creation unit 102 described with reference to FIG. 1 etc. The order determination unit 304 may be achieved by functions similar to those included in the order determination unit 106 described with reference to FIG. 1 etc. The action determination unit 306 may be achieved by functions similar to those included in the action determination unit 108 described with reference to FIG. 1 etc.

FIG. 12 is a flowchart showing a policy creation method executed by the policy creation apparatus 300 according to the third example embodiment.

The rule creation unit 302 creates a plurality of rule sets including a predetermined number of rules in which a condition for determining a state of an object (i.e., a target) is combined with an action in the state (Step S302). For example, the rule creation unit 302 creates N rule sets including I rules as described above. In other words, the rule creation unit 302 creates the rule sets including a plurality of rules that are a combination of a condition for determining the necessity of an action to be taken regarding the object and the action to be performed when the condition holds.

The order determination unit 304 determines the order of rules for each of a plurality of the rule sets and creates policies expressed by the decision list corresponding to the rule set in which the order of the rules is determined (Step S304). That is, the order determination unit 304 determines the order of the rules in each of the plurality of the rule sets.

Then, the action determination unit 306 determines whether or not the state of the object conforms to the condition for the rule in the determined order and determines the action to be executed (Step S306). That is, the action determination unit 306 determines whether or not the condition holds in accordance with the determined order, and determines the action when the condition holds.

Since the policy creation apparatus 300 according to the third example embodiment is configured as described above, it can create a decision list in which the order is determined, as a policy. Here, since the decision list is expressed in the form of a list such as a decision list, the visibility of it is high for the user. Therefore, policies with high quality and high visibility can be created.

### (Hardware Configuration Example)

A configuration example of hardware resources in a case in which the above-described policy creation apparatus according to each of the example embodiments is implemented using one calculation processing device (information processing apparatus, computer) will be described. Note that the policy creation apparatus according to each of the example embodiments may be physically or functionally implemented by using at least two calculation processing devices. Further, the policy creation apparatus according to each of the example embodiments may be implemented as a dedicated apparatus or may be implemented by a general-purpose information processing apparatus.

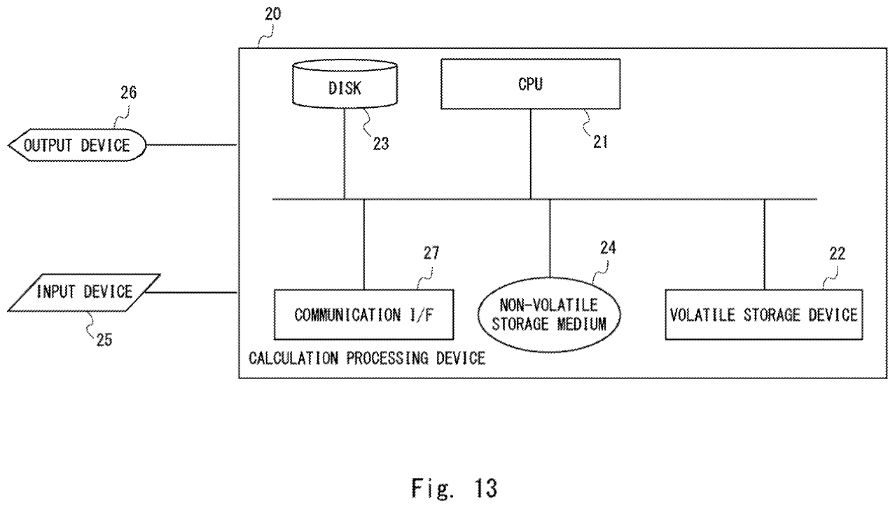

FIG. 13 is a block diagram schematically showing a hardware configuration example of a calculation processing device capable of achieving the policy creation apparatus according to each of the example embodiments. A calculation processing device 20 includes a Central Processing Unit (CPU) 21, a volatile storage device 22, a disk 23, a non-volatile storage medium 24, and a communication Interface (IF) 27. It can therefore be said that the policy creation apparatus according to each of the example embodiments includes the CPU 21, the volatile storage device 22, the disk 23, the non-volatile storage medium 24, and the communication IF 27. The calculation processing device 20 may be connected to an input device 25 and an output device 26. The calculation processing device 20 may include the input device 25 and the output device 26. Further, the calculation processing device 20 is able to transmit/receive information to/from another calculation processing device and a communication apparatus via the communication IF 27.

The non-volatile storage medium 24 is, for example, a computer-readable Compact Disc or Digital Versatile Disc. Further, the non-volatile storage medium 24 may be a Universal Serial Bus (USB) memory, a Solid State Drive or the like. The non-volatile storage medium 24 allows a related program to be holdable and portable without power supply. The non-volatile storage medium 24 is not limited to the above-described media. Further, a related program may be supplied via the communication IF 27 and a communication network in place of the non-volatile storage medium 24.

The volatile storage device 22, which is a computer-readable device, is able to temporarily store data. The volatile storage device 22 is a memory such as a dynamic random Access memory (DRAM), a static random Access memory (SRAM) or the like.

Specifically, when executing a software program (a computer program: hereinafter simply referred to as “program”) stored in the disk 23, the CPU 21 duplicates the program in the volatile storage device 22 and executes arithmetic processing. The CPU 21 reads out data required for executing the program from the volatile storage device 22. When it is required to display the result of the output, the CPU 21 displays it on the output device 26. When the program is input from the outside, the CPU 21 acquires the program from the input device 25. The CPU 21 interprets and executes the policy creation program (FIGS. 2 to 4, or FIG. 12) that corresponds to the functions (processes) of the respective components shown in FIG. 1 or 11 described above. The CPU 21 executes processing described in each of the above-described example embodiments. In other words, the functions of each of the respective components shown in FIG. 1 or 11 described above may be achieved by the CPU 21 executing the policy creation program stored in the disk 23 or the volatile storage device 22.

That is, each of the example embodiments may be achieved also by the above-described policy creation program. Further, it can be understood that each of the above-described example embodiments can also be achieved with a computer-readable non-volatile storage medium in which the above-described policy creation program is recorded.

### Modified Examples

Note that the present disclosure is not limited to the above-described embodiments and may be changed as appropriate without departing from the spirit of the present disclosure. For example, in the aforementioned flowchart, the order of the processes (steps) may be changed as appropriate. Further, one or more of the plurality of processes (steps) may be omitted.

The timing at which the order parameter calculation unit 104 updates the model may be arbitrary. Therefore, in the flowchart shown in FIG. 2, in some loops (S102 to S160), the processing of S156 to S158 may be performed without updating the model. This means that the model does not have to be constantly updated in every loop.

In the above example, the program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), CD-Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

While the present invention has been described above with reference to the example embodiments, the present invention is not limited by the aforementioned descriptions. Various changes that can be understood by one skilled in the art may be made within the scope of the invention to the configurations and the details of the present invention.

The whole or part of the above example embodiments can be described as, but not limited to, the following supplementary notes.

(Supplementary Note 1)

A policy creation apparatus comprising:
rule creation means for creating a plurality of rule sets including a plurality of rules, each of the rules being a combination of a condition for determining a necessity of an action to be taken regarding an object and the action to be performed when the condition holds;
order determination means for determining an order of the rules in each of the plurality of rule sets; and
action determination means for determining whether or not the condition holds in accordance with the determined order, and determining the action when the condition holds.

(Supplementary Note 2)

The policy creation apparatus according to Supplementary Note 1, wherein
the rule is expressed by a set of rule parameters that follow a predetermined rule creation criterion, and
the rule creation means determines at least one of the condition and the action in the rule by calculating the value of the rule parameter in accordance with the rule creation criterion.

(Supplementary Note 3)

The policy creation apparatus according to Supplementary Note 2, wherein
the rule creation means creates the rule in which the condition and the action are randomly combined.

(Supplementary Note 4)

The policy creation apparatus according to any one of Supplementary Notes 1 to 3, further comprising order parameter calculation means for calculating order parameters for determining the order of the plurality of rules in the rule set,
wherein the order determination means determines the order of the rules in the rule set according to the order parameters.

(Supplementary Note 5)

The policy creation apparatus according to Supplementary Note 4, wherein
the rule is expressed by a set of rule parameters that follow a predetermined rule creation criterion,
the rule creation means determines at least one of the condition and the action in the rule by calculating the value of the rule parameter in accordance with the rule creation criterion, and
the order parameter calculation means calculates the order parameters according to the rule parameters.

(Supplementary Note 6)

The policy creation apparatus according to Supplementary Note 4 or 5, further comprising action evaluation means for determining a quality of the determined action,
wherein the order parameter calculation means updates model for calculating the order parameters so that the quality of the action increases.

(Supplementary Note 7)

The policy creation apparatus according to any one of Supplementary Notes 1 to 6, wherein the order determination means creates a plurality of policies corresponding to the ordered rule sets,
the policy creation apparatus further comprising:
policy evaluation means for determining a quality of the determined action and determining a quality of each of the plurality of policies based on the quality of the determined action; and
policy selection means for selecting a policy whose quality that has been determined is high from among a plurality of the created policies.

(Supplementary Note 8)

The policy creation apparatus according to Supplementary Note 7, wherein the rule creation means creates new rule sets using the selected policy.

(Supplementary Note 9)

The policy creation apparatus according to Supplementary Note 8, wherein
the rule is expressed by a set of rule parameters that follow a predetermined rule creation criterion,
the rule creation criterion is updated by using the selected policy, and
the rule creation means creates the new rule sets by calculating the rule parameters that follow the updated rule creation criterion.

(Supplementary Note 10)

The policy creation apparatus according to any one of Supplementary Notes 1 to 9, wherein the action determination means determines a control value for controlling the action of the object by using a state of the object and the created policy, and gives instructions to execute the action in accordance with the determined control value.

(Supplementary Note 11)

A control apparatus comprising:
the policy creation apparatus according to any one of Supplementary Notes 1 to 10; and
a controller configured to perform control regarding the object in accordance with the action determined by the policy creation apparatus.

(Supplementary Note 12)

A policy creation method performed by an information processing apparatus, comprising:
creating a plurality of rule sets including a plurality of rules, each of the rules being a combination of a condition for determining a necessity of an action to be taken regarding an object and the action to be performed when the condition holds;
determining an order of the rules in each of the plurality of rule sets; and
determining whether or not the condition holds in accordance with the determined order, and determining the action when the condition holds.

(Supplementary Note 13)

A non-transitory computer readable medium storing a policy creation program for causing a computer to achieve:
a function of creating a plurality of rule sets including a plurality of rules, each of the rules being a combination of a condition for determining a necessity of an action to be taken regarding an object and the action to be performed when the condition holds;
a function of determining an order of the rules in each of the plurality of rule sets; and
a function of determining whether or not the condition holds in accordance with the determined order, and determining the action when the condition holds.

### REFERENCE SIGNS LIST

50 Control Apparatus
52 Controller
100 Policy Creation Apparatus
102 Rule Creation Unit
104 Order Parameter Calculation Unit
106 Order Determination Unit
108 Action Determination Unit
110 Policy Evaluation Unit
112 Action Evaluation Unit
114 Comprehensive Evaluation Unit
120 Policy Selection Unit
122 Criterion Update Unit
126 Policy Evaluation Information Storage Unit
170 Target
300 Policy Creation Apparatus
302 Rule Creation Unit
304 Order Determination Unit
306 Action Determination Unit

What is claimed is:

1. A policy creation apparatus comprising:
at least one memory configured to store instructions; and
at least one processor configured to execute the instructions to:
create a plurality of rule sets including a plurality of rules, each of the rules being a combination of a condition for determining a necessity of an action to be taken regarding an object and the action to be performed when the condition holds;
determine an order of the rules in each of the plurality of rule sets; and
determine whether or not the condition holds in accordance with the determined order, and determine the action when the condition holds.

2. The policy creation apparatus according to claim 1, wherein
the rule is expressed by a set of rule parameters that follow a predetermined rule creation criterion, and
the at least one processor is further configured to execute the instructions to determine at least one of the condition and the action in the rule by calculating the value of the rule parameter in accordance with the rule creation criterion.

3. The policy creation apparatus according to claim 2, wherein
the at least one processor is further configured to execute the instructions to create the rule in which the condition and the action are randomly combined.

4. The policy creation apparatus according to claim 1, wherein the at least one processor is further configured to execute the instructions to calculate order parameters for determining the order of the plurality of rules in the rule set, and
the at least one processor is further configured to execute the instructions to determine the order of the rules in the rule set according to the order parameters.

5. The policy creation apparatus according to claim 4, wherein
the rule is expressed by a set of rule parameters that follow a predetermined rule creation criterion,
the at least one processor is further configured to execute the instructions to determine at least one of the condition and the action in the rule by calculating the value of the rule parameter in accordance with the rule creation criterion, and
the at least one processor is further configured to execute the instructions to calculate the order parameters according to the rule parameters.

6. The policy creation apparatus according to claim 4, wherein the at least one processor is further configured to execute the instructions to determine a quality of the determined action, and
the at least one processor is further configured to execute the instructions to update model for calculating the order parameters so that the quality of the action increases.

7. The policy creation apparatus according to claim 1, wherein the at least one processor is further configured to execute the instructions to create a plurality of policies corresponding to the ordered rule sets,
the at least one processor is further configured to execute the instructions to determine a quality of the determined action and determine a quality of each of the plurality of policies based on the quality of the determined action; and
the at least one processor is further configured to execute the instructions to select a policy whose quality that has been determined is high from among a plurality of the created policies.

8. The policy creation apparatus according to claim 7, wherein the at least one processor is further configured to execute the instructions to create new rule sets using the selected policy.

9. The policy creation apparatus according to claim 8, wherein
the rule is expressed by a set of rule parameters that follow a predetermined rule creation criterion,
the rule creation criterion is updated by using the selected policy, and
the at least one processor is further configured to execute the instructions to create the new rule sets by calculating the rule parameters that follow the updated rule creation criterion.

10. The policy creation apparatus according to claim 1, wherein the at least one processor is further configured to execute the instructions to determine a control value for controlling the action of the object by using a state of the object and the created policy, and gives instructions to execute the action in accordance with the determined control value.

11. (canceled)

12. A policy creation method performed by an information processing apparatus, comprising:
creating a plurality of rule sets including a plurality of rules, each of the rules being a combination of a condition for determining a necessity of an action to be taken regarding an object and the action to be performed when the condition holds;
determining an order of the rules in each of the plurality of rule sets; and
determining whether or not the condition holds in accordance with the determined order, and determining the action when the condition holds.

13. A non-transitory computer readable medium storing a policy creation program for causing a computer to achieve:
a function of creating a plurality of rule sets including a plurality of rules, each of the rules being a combination of a condition for determining a necessity of an action to be taken regarding an object and the action to be performed when the condition holds;
a function of determining an order of the rules in each of the plurality of rule sets; and
a function of determining whether or not the condition holds in accordance with the determined order, and determining the action when the condition holds.
